(19) United States
(12) Patent Application Publication
(10) Pub. No.: US 2019/0236415 A1
(43) Pub. Date: Aug. 1, 2019

(54) METHOD OF CLASSIFICATION OF AN OBJECT AND SYSTEM THEREOF

(71) Applicant: Beamr Imaging Ltd., Tel-Aviv (IL)

(72) Inventors: Sergey PYKO, St. Petersburg (RU); Boris FILIPPOV, St. Petersburg (RU)

(21) Appl. No.: 16/238,836

(22) Filed: Jan. 3, 2019

(30) Foreign Application Priority Data
Jan. 30, 2018 (RU) 2018103352

(51) Int. Cl. G06K 9/62; G06F 16/901; G06N 20/20

(52) U.S. Cl. CPC G06K 9/6282; G06N 20/20; G06F 16/9027; G06K 9/6292

(57) ABSTRACT

There are provided a system and method of classification of an object represented by input data comprising a plurality of components. The method includes obtaining a restructured tree corresponding to a decision tree, providing appropriate components selected from the plurality of components to corresponding duplicated non-leaf nodes of each given layer to be used in duplicated condition associated thereof; for each given layer of the restructured tree that comprises duplicated non-leaf nodes, generating a per layer output by applying the duplicated condition associated with each duplicated non-leaf node on corresponding appropriate component, and applying an inversion mask to the per layer output to obtain a corrected per layer output, giving rise to a plurality of corrected per layer outputs, and combining the plurality of corrected per layer outputs giving rise to the classification of the object.

### TECHNICAL FIELD

The presently disclosed subject matter relates, in general, to the field of classification, and more specifically, to methods and systems for decision tree based classification.

### BACKGROUND

Classification is a general process related to categorization, in which objects are recognized, differentiated, and understood. In machine learning, classification is the problem of identifying to which of a set of categories a new observation (or instance) belongs, on the basis of a training set of data containing observations whose category membership is known. An algorithm or function that implements classification and maps representative input data to a category is known as a classifier.

Different classification techniques, such as, e.g., decision tree classifiers, rule-based classifiers, neural networks, support vector machines, and naive Bayes classifiers, etc., can be used to solve a classification problem. Each technique adopts a learning algorithm to identify a model that best fits the relationship between an attribute set and class label of the input data. Upon learning, a predictive model is created which is used to predict class labels of previously unknown instances.

A decision tree classifier organizes a series of conditional tests (questions) about the attributes of the input data in a tree-like structure. Each internal node (i.e., non-leaf node) represents a test on an attribute, each branch represents the outcome of the test, and each leaf node represents a class label (a decision taken after computing all attributes). The paths from root to leaf represent classification rules.

### GENERAL DESCRIPTION

In accordance with certain aspects of the presently disclosed subject matter, there is provided a method of classification of an object represented by input data comprising a plurality of components, the method performed by a processor capable of parallel processing and comprising: i) obtaining a restructured tree corresponding to a decision tree, wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test, and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree; ii) providing appropriate components selected from the plurality of components to corresponding duplicated non-leaf nodes of each given layer to be used in the duplicated condition associated thereof; iii) for each given layer of the restructured tree that comprises duplicated non-leaf nodes, generating a per layer output by applying the duplicated condition associated with each duplicated non-leaf node on the corresponding appropriate component, and applying an inversion mask to the per layer output to obtain a corrected per layer output, giving rise to a plurality of corrected per layer outputs; and iv) combining the plurality of corrected per layer outputs giving rise to the classification of the object.

In addition to the above features, the method according to this aspect of the presently disclosed subject matter can comprise one or more of features (i) to (xiii) listed below, in any desired combination or permutation which is technically possible:
(i). The object can be a first pixel group comprising one or more pixels from an input image, and the input data comprises a plurality of components corresponding to the first pixel group, and wherein the classification of the first pixel group is indicative of a category thereof.
(ii). The plurality of components can be selected from a group comprising luma and chroma components and one or more components derived from pixel values of the one or more pixels in the first pixel group and adjacent pixels thereto.
(iii). The method can further comprise repeating the steps ii)-iv) for one or more subsequent pixel groups of the input image, thereby giving rise to classification of each of the one or more subsequent pixel groups.
(iv). The method can further comprise providing classification of the input image based on the classification of the first pixel group and each of the one or more subsequent pixel groups.
(v). The restructured tree can be generated by:
   a) duplicating each given non-leaf node in the decision tree according to the number of leaf nodes linked thereto, giving rise to a set of duplicated non-leaf nodes corresponding to the given non-leaf node, and associating each duplicated non-leaf node in the set with a respective duplicated condition based on the condition comprised in the conditional test associated with the given non-leaf node, wherein the respective duplicated condition comprises the same operator as comprised in the condition or an opposite operator, thereby providing a plurality of sets of duplicated non-leaf nodes corresponding to a plurality of non-leaf nodes in the decision tree; and
   b) unifying all operators as comprised in respective duplicated conditions associated with all duplicated non-leaf nodes in the plurality of sets of duplicated non-leaf nodes to a common operator by modifying one or more operators thereof that are opposite to the common operator, giving rise to the restructured tree.
(vi). The applying an inversion mask can comprise providing an inversion mask for each given layer based on one or more modified operators in the given layer, and applying the inversion mask by performing an XOR operation between the inversion mask and the per layer output to obtain the corrected per layer output.
(vii). The providing appropriate components can be performed by generating, for each given layer comprising duplicated non-leaf nodes, an input vector comprising the appropriate components corresponding to the duplicated non-leaf nodes using a plurality of input masks.
(viii). The generating an input vector can comprise:
   duplicating each of the plurality of components of the input data according to the number of duplicated non-leaf nodes in the given layer, giving rise to a plurality of duplicated component vectors;
   providing an input mask for each given duplicated component vector according to position of one or more duplicated non-leaf nodes in the given layer, the one or more duplicated non-leaf nodes associated with a duplicated condition to be applied on the component comprised in the given duplicated component vector, giving rise to a plurality of input masks corresponding to the plurality of duplicated component vectors;
   applying the plurality of input masks to the corresponding plurality of duplicated component vectors, giving rise to a plurality of masked duplicated component vectors; and
   combining the plurality of masked duplicated component vectors to form the input vector.
(ix). The combining the plurality of corrected per layer outputs can comprise applying an AND operation among the plurality of corrected per layer outputs.
(x). The processor can support SIMD and at least one of the providing appropriate components to corresponding duplicated non-leaf nodes, the applying the duplicated condition on the corresponding appropriate component, the applying an inversion mask to the per layer output and the combining the plurality of corrected per layer outputs can be performed, by the processor, in parallel for at least part of duplicated non-leaf nodes in the given layer.
(xi). The processor can support SIMD and comprise a plurality of multi-component registers each having a fixed width and data corresponding to each layer of the restructured tree exceeds the fixed width, and the restructured tree can be divided into a plurality of sub-trees such that at least one sub-tree of the plurality of sub-trees utilizes the fixed width.
(xii). The processor can support SIMD and comprise a plurality of multi-component registers each having a fixed width capable of holding data corresponding to at least one layer of at least one restructured tree, and the data can be packed into the plurality of multi-component registers and processed by the processor in parallel.
(xiii). Data corresponding to at least one layer from at least one sub-tree can be packed into the plurality of multi-component registers and processed by the processor concurrently.

In accordance with other aspects of the presently disclosed subject matter, there is provided a computerized system capable of classifying an object represented by input data comprising a plurality of components, the system comprising a processing and memory circuitry (PMC) capable of parallel processing and configured to: i) obtain a restructured tree corresponding to a decision tree, wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test, and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree; ii) provide appropriate components selected from the plurality of components to corresponding duplicated non-leaf nodes of each given layer to be used in the duplicated condition associated thereof; iii) for each given layer of the restructured tree that comprises duplicated non-leaf nodes, generate a per layer output by applying the duplicated condition associated with each duplicated non-leaf node on the corresponding appropriate component, and apply an inversion mask to the per layer output to obtain a corrected per layer output, giving rise to a plurality of corrected per layer outputs; and iv) combine the plurality of corrected per layer outputs giving rise to the classification of the object.

This aspect of the disclosed subject matter can comprise one or more of features (i) to (xiii) listed above with respect to the method, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform a method classification of an object represented by input data comprising a plurality of components, the method comprising: i) obtaining a restructured tree corresponding to a decision tree, wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test, and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree; ii) providing appropriate components selected from the plurality of components to corresponding duplicated non-leaf nodes of each given layer to be used in the duplicated condition associated thereof; iii) for each given layer of the restructured tree that comprises duplicated non-leaf nodes, generating a per layer output by applying the duplicated condition associated with each duplicated non-leaf node on the corresponding appropriate component, and applying an inversion mask to the per layer output to obtain a corrected per layer output, giving rise to a plurality of corrected per layer outputs; and iv) combining the plurality of corrected per layer outputs giving rise to the classification of the object.

This aspect of the disclosed subject matter can comprise one or more of features (i) to (xiii) listed above with respect to the method, mutatis mutandis, in any desired combination or permutation which is technically possible.

In accordance with other aspects of the presently disclosed subject matter, there is provided a non-transitory computer readable medium comprising: data representative of a restructured tree corresponding to a decision tree, the restructured tree usable for classifying an object represented by input data comprising a plurality of components; wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test; and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree. The restructured tree can be usable by a processor capable of parallel processing for performing the classifying of an object.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 schematically illustrates a functional block diagram of a classification system capable of classifying an object in accordance with certain embodiments of the presently disclosed subject matter;

FIG. 2 illustrates a generalized flowchart of classification of an object represented by input data in accordance with certain embodiments of the presently disclosed subject matter;

FIG. 3 illustrates a generalized flowchart of generating a restructured tree based on a corresponding decision tree in accordance with certain embodiments of the presently disclosed subject matter;

FIG. 4 illustrates a generalized flowchart of providing appropriate components to corresponding duplicated non-leaf nodes of each given layer in accordance with certain embodiments of the presently disclosed subject matter;

FIGS. 5a to 5c illustrate an example of a decision tree and a corresponding restructured tree generated therefrom in accordance with certain embodiments of the presently disclosed subject matter;

FIG. 6 is a schematic illustration of an exemplified implementation of the generation of an input vector for a given layer in accordance with certain embodiments of the presently disclosed subject matter; and

FIG. 7 illustrates a schematic illustration of exemplified registers holding data corresponding to layers from two restructured trees in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “obtaining”, “applying”, “receiving”, “duplicating”, “providing”, “generating”, “combining”, “repeating”, “unifying”, “modifying”, “performing”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the classification system and parts thereof disclosed in the present application.

The operations in accordance with the teachings herein can be performed by a computer specially constructed for the desired purposes or by a general purpose computer specially configured for the desired purpose by a computer program stored in a non-transitory computer readable storage medium.

The terms “non-transitory memory”, “non-transitory storage medium” and “non-transitory computer readable storage medium” used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

In embodiments of the presently disclosed subject matter one or more stages illustrated in the figures may be executed in a different order and/or one or more groups of stages may be executed simultaneously and vice versa.

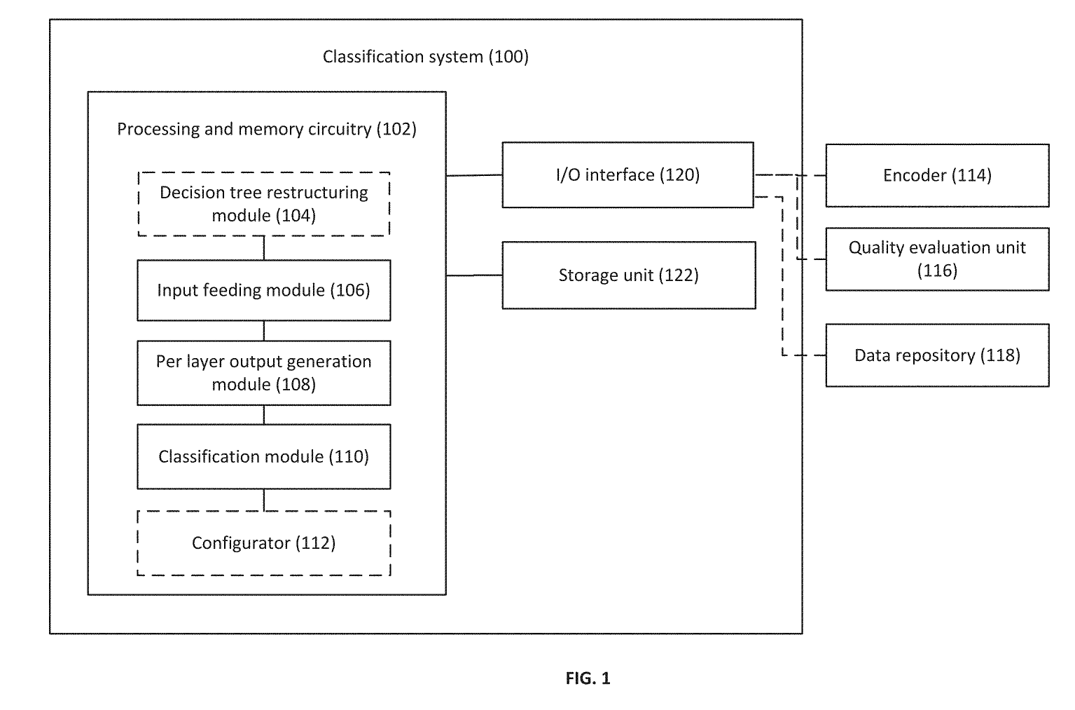

Bearing this in mind, attention is drawn to FIG. 1, schematically illustrating a functional block diagram of a classification system capable of classifying an object in accordance with certain embodiments of the presently disclosed subject matter.

The system 100 illustrated in FIG. 1 is a computer-based classification system capable of classifying an object represented by input data comprising a plurality of components. As aforementioned, generally speaking, a classification system can be implemented using different classification techniques, such as, e.g., decision tree classifiers, rule-based classifiers, neural networks, support vector machines, and naive Bayes classifiers, etc. The classification system referred to herein in accordance with certain embodiments of the present disclosure can be implemented using a decision tree based classification.

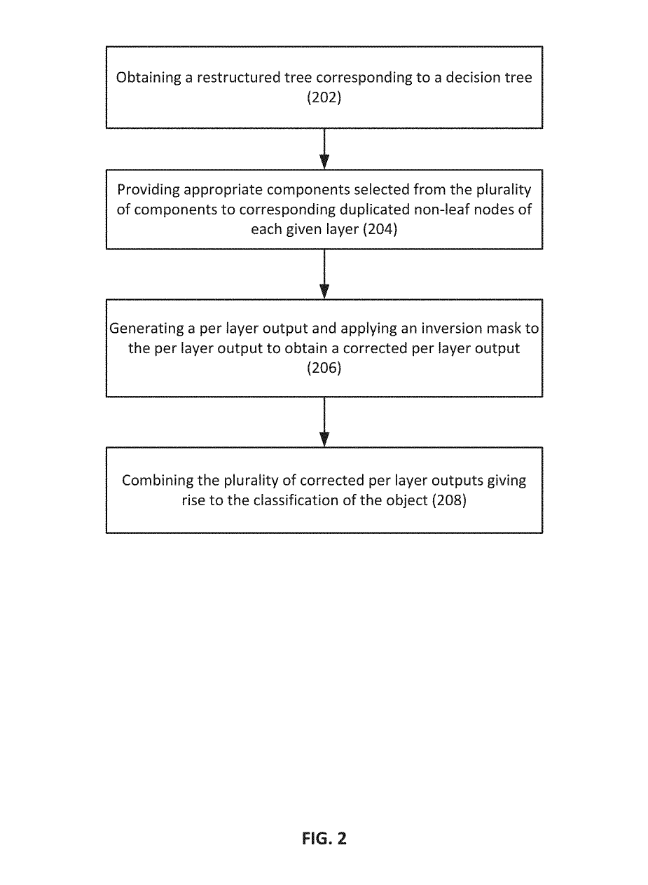

System 100 can comprise a processing and memory circuitry (PMC) 102 operatively connected to a hardware-based I/O interface 120 and a storage unit 122. PMC 102 is configured to provide all processing necessary for operating system 100 which is further detailed with reference to FIGS. 2-4. PMC 102 comprises a processor (not shown separately) and a memory (not shown separately). The processor of PMC 102 is capable of parallel processing and can be configured to execute several functional modules in accordance with computer-readable instructions implemented on a non-transitory computer-readable memory comprised in the PMC. Such functional modules are referred to hereinafter as comprised in the PMC. In some cases, system 100 can be operatively connected to one or more external data repositories 118.

System 100 can be configured to obtain, via an I/O interface 120, an input object (also referred to herein as object) to be classified. The object can be represented by, or associated with, input data comprising a plurality of input components (also referred to herein as components). The plurality of components can correspond to a plurality of attributes or features that characterize the object. The input object can be retrieved from the storage unit 122, or received from the external data repositories 118 and/or an external system or provider. According to certain embodiments, the input object can be a first pixel group comprising one or more pixels from an input image.

In certain embodiments, functional modules comprised in the PMC 102 can comprise an Input feeding module 106, a Per layer output generation module 108, and a Classification module 110. Optionally, the functional modules can further comprise a Decision tree restructuring module 104 and/or a Configurator 112. The functional modules comprised in the PMC are operatively connected with each other. The PMC 102 can be configured to obtain/provide a restructured tree corresponding to a decision tree. The restructured tree can be pre-prepared and data representative thereof can be stored in the storage unit 122 which can be retrieved and used by the PMC for further processing. In some cases, the restructured tree can be received, via an I/O interface 120, from an external source. Alternatively, the restructured tree can be generated by the Decision tree restructuring module 104 as comprised in the PMC based on a corresponding decision tree.

The structure of the restructured tree and the corresponding decision tree are now described in accordance with certain embodiments of the presently disclosed subject matter. The decision tree referred to herein can comprise a plurality of layers each comprising one or more nodes. A layer (except for the first layer which comprises the root node) can be defined as all the nodes comprised therein having the same distance to the root node. Each node in the decision tree is either a leaf node or non-leaf node. A leaf node is a node that does not have any subsequent branches or children (i.e., connections to subsequent nodes in a subsequent layer). Each leaf node can represent a class or category of the input object (i.e., a decision taken after computing all input components/attributes). The classes/categories represented by the leaf nodes can be predetermined when creating the decision tree classifier. In some cases, one or more leaf nodes can represent the same class.

A non-leaf node (also termed as internal node) is a node that has subsequent branches (i.e., connections to subsequent nodes in a subsequent layer). The decision tree comprises a plurality of non-leaf nodes. In certain embodiments, each non-leaf node in the decision tree can be associated with, or can represent, a binary conditional test. The binary conditional test is a test of a condition that is capable of receiving, as input, a given component of the plurality of components of the input data so as to be applied on the received given component. The condition comprises an operator. The binary conditional test has two possible outcomes/results (e.g., true or false, or any other representations of binary results). The given non-leaf node is connected to two subsequent nodes in a subsequent layer in accordance with the two possible results of the conditional test.

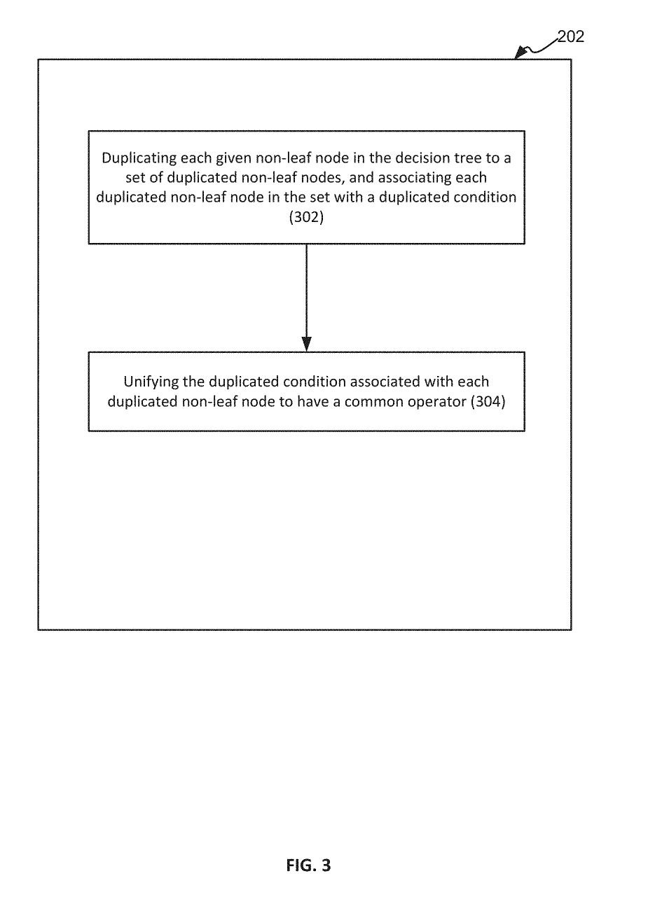

The restructured tree corresponding to the decision tree comprises a plurality of sets of duplicated non-leaf nodes corresponding to the plurality of non-leaf nodes in the decision tree. Each set of duplicated non-leaf nodes can be duplicated from a corresponding non-leaf node according to the number of leaf nodes linked thereto (i.e., linked to the non-leaf node). Each given duplicated non-leaf node in the plurality of sets of duplicated non-leaf nodes is associated with a respective duplicated condition. The respective duplicated condition is duplicated based on the condition comprised in the conditional test associated with the given duplicated non-leaf node. The respective duplicated condition comprises a common operator that is common in all duplicated conditions associated with respective duplicated non-leaf nodes in the restructured tree. In other words, all duplicated non-leaf nodes in the restructured tree share the same common operator. The generation process of the restructured tree is described below in further detail with reference to FIGS. 2 and 3.

Upon obtaining of the restructured tree, the Input feeding module 106 can be configured to provide appropriate components (i.e., components that are required to be received as input for respective duplicated non-leaf nodes so as to apply the duplicated condition thereon) selected from the plurality of components to corresponding duplicated non-leaf nodes of each given layer to be used in the duplicated condition associated thereof.

The Per layer output generation module 108 can be configured to, for each given layer of the restructured tree that comprises duplicated non-leaf nodes, generate a per layer output by applying the duplicated condition associated with each duplicated non-leaf node on the corresponding appropriate component, and apply an inversion mask to the per layer output to obtain a corrected per layer output, giving rise to a plurality of corrected per layer outputs. The Classification module 110 can be configured to combine the plurality of corrected per layer outputs giving rise to the classification of the object.

Optionally, in some embodiments, the classification can be performed repetitively for one or more subsequent pixel groups of the input image. A classification of the input image, or of a segment within the input image, can be obtained based on the classification of the first pixel group as well as classification of each of the one or more subsequent pixel groups. Operations of the system 100, PMC 102 and the functional modules therein will be further detailed with reference to FIGS. 2-4.

Optionally, in some cases, system 100 can be operatively connected to an Encoder 114 and/or a Quality evaluation unit 116. The Encoder 114 can comprise one or more image encoders and/or one or more video encoders. The Encoder 114 can be configured to encode/convert media content (such as, e.g., image, video etc.) into standardized formats such as, e.g., image and video bitstreams. The term “encode” or “encoding” used in this patent specification should be expansively construed to cover any kind of compression that converts raw (uncompressed) digital media to a compressed format, as well as recompression that converts decoded or decompressed media to a re-encoded or recompressed format. The Quality evaluation unit 116 can be configured to evaluate quality of the encoded image or video using one or more suitable quality measures. The PMC can further comprise a Configurator 112 that can be used to configure the Encoder 114 and/or the Quality evaluation unit 116 using the classification of the input image, or of a segment thereof, by way of, e.g., providing configuration instruction(s).

In certain embodiments, the Encoder 114 and/or the Quality evaluation unit 116 can be implemented as a standalone computer as being external to the system 100 and operates in data communication with system 100 via I/O interface 120. Alternatively, the functionality of the Encoder 114 and/or the Quality evaluation unit 116, or at least part thereof, can be integrated within the system 100. In some cases, the Configurator 112 can be implemented as part of the Encoder 114 and/or the Quality evaluation unit 116, instead of being comprised in the PMC of system 100.

The I/O interface 120 can be configured to obtain, as input, the input data representative of the input object to be classified, and/or the restructured tree, and provide, as output, classification of one or more pixel groups and/or classification of the input image, or of a segment thereof, and/or configuration instruction(s). The storage unit 122 comprises a non-transitory computer readable storage medium. In some embodiments, the storage unit 122 can be configured to store any input as received, and/or intermediate results and/or output as generated by system 100, including one or more of the following: the input object, the representative input data, the restructured tree, the decision tree, input vector, inversion masks, input masks, per layer outputs, corrected per layer outputs, classification of one or more pixel groups and/or classification of the input image, and/or configuration instruction(s). According to certain embodiments, the storage unit 122 can also comprise computer-readable instructions embodied therein to be executed by the processor for implementing the process of classification as described below with reference to FIGS. 2-4.

It is also noted that the system illustrated in FIG. 1 can be implemented in a distributed computing environment, in which the aforementioned functional modules shown in FIG. 1 can be distributed over several local and/or remote devices, and can be linked through a communication network.

Those versed in the art will readily appreciate that the teachings of the presently disclosed subject matter are not bound by the system illustrated in FIG. 1; equivalent and/or modified functionality can be consolidated or divided in another manner and can be implemented in any appropriate combination of software with firmware and hardware. The system in FIG. 1 can be a standalone network entity, or integrated, fully or partly, with other network entities. Those skilled in the art will also readily appreciate that the data repositories or storage unit therein can be shared with other systems or be provided by other systems, including third party equipment.

While not necessarily so, the process of operation of system 100 can correspond to some or all of the stages of the methods described with respect to FIGS. 2-4. Likewise, the methods described with respect to FIGS. 2-4 and their possible implementations can be implemented by system 100. It is therefore noted that embodiments discussed in relation to the methods described with respect to FIGS. 2-4 can also be implemented, mutatis mutandis as various embodiments of the system 100, and vice versa.

Referring now to FIG. 2, there is illustrated a generalized flowchart of classification of an object represented by input data in accordance with certain embodiments of the presently disclosed subject matter.

The input object to be classified, as referred to herein, should be expansively construed to cover any object, observation or instance that can be represented/characterized by a plurality of components/attributes so as to enable the classification thereof based on such components/attributes. In one embodiment, the input object is a given pixel group (also referred to as the first pixel group) comprising one or more pixels from an input image, and the input data representing the input object comprises a plurality of components corresponding to the first pixel group. It is to be noted that in different cases, the first pixel group can be construed to comprise different numbers of pixels, ranging from a single pixel, several pixels of an input image, to the entire input image. In one example, the first pixel group can be a single pixel. In another example, the first pixel group can comprise a N×N (e.g., 4×4 or 8×8) pixel group. Without limiting the scope of the disclosure in any way, it should be noted that the term “image” or “input image” used in the specification should be expansively construed to refer to any of the following: an image, a single video picture, frame, field, or slice of an input video stream, etc.

In certain embodiments, the plurality of components of the input data can be selected from a group comprising luma and chroma components and one or more components derived from pixel values of the one or more pixels in the first pixel group and adjacent pixels thereto. The luma component represents the brightness of the pixels in the first pixel group (i.e., the black-and-white or achromatic portion of the pixels), and the chroma represent the color information of the pixels. The present disclosure is not limited to a specific colorspace used to represent the input image or the pixels thereof. In one example, the luma and chroma components can include the Y, U and V components of the one or more pixels in the pixel group. In one embodiment, a derived component included in the input data can be a variance component that can be derived from pixel values of pixels within the first pixel group and pixels that are adjacent to the pixel group. For instance, in cases where the pixel group is a given single pixel, the variance component can be derived from the pixel value of the given pixel and the neighboring pixels (e.g., surrounding pixels or part thereof). While not necessarily so, in some cases, the input data that comprises the plurality of components can be represented in the form of a vector, a list, or any other forms that are suitable for representing such multi-component input data.

In some embodiments, the classification of the first pixel group can be indicative of a category/class thereof. By way of example, the class/category can indicate whether the pixel group represents a specific texture and/or color combination, such as, e.g., skin, grass, face, sky, gravel, parquet, image with high film grain, etc. Such classification information can be used for facilitating/optimizing the encoding of the input image and/or quality evaluation of the encoded content, as will be described below.

Referring now to the flowchart of FIG. 2, a restructured tree corresponding to a decision tree can be obtained/provided (e.g., by the Decision tree restructuring module 104 in PMC 102, or via I/O interface 120, or from the storage unit 122, as illustrated in FIG. 1). The structure of the restructured tree and the corresponding decision tree is described above with reference to FIG. 1.

In some cases, a decision tree classifier employing a traditional decision tree structure such as described above with reference to the decision tree can result in low system performance such as, e.g., time-consuming and inefficient classification. This may be caused by several factors. First, each non-leaf node in the decision tree has subsequent branches/splits, through which the non-leaf node is connected to subsequent nodes in a subsequent layer. For each input object and the representative input data thereof, starting from the top non-leaf node (i.e., root node), the selection of branches in each layer depends on the result of the conditional test associated with each non-leaf node which in turn depends on a specific input component of the input data to be received by the non-leaf node. The binary conditional test, which employs an “if-else” construction, can create a problem with prediction of instruction sequence, selection of data and vectorization of calculation. For example, in case of a processor capable of instruction pipelining, such conditional structure may cause a hazard, and may stall and delay processing. Second, the plurality of components of the representative input data can possibly be placed in different locations in memory which cannot be loaded by a single instruction. Therefore, in order to provide appropriate components for each non-leaf node, memory needs to be accessed multiple times for fetching each of the components and writing back the computation results of each non-leaf node afterwards. The distribution of components in different memory locations can cause problems in the cache operation, thus reducing efficiency of cache load and hits, and causing the memory access operations to be much slower.

In order to address the above problem, one aspect of the present disclosure is to restructure the decision tree classifier in such a way so as to exclude the branching as much as possible thereby enabling parallel processing. The proposed restructure implementation can accelerate decision generation through parallelized (and also pipelined if so configured) computations. The present proposal is especially beneficial when using appropriate hardware infrastructure that is capable of parallel processing, such as processors (e.g., CPUs) that support SIMD (Single Instruction, Multiple Data) schemes, or processors that specialize in graphical processing (e.g., Graphics Processing Unit (GPU)), as will be described below in further detail.

As aforementioned, the restructured tree can be pre-prepared and stored in the storage unit 122 which can be retrieved by the PMC. In some cases, the restructured tree can be received, via an I/O interface 120, from an external source. Alternatively, the restructured tree can be generated by the Decision tree restructuring module 104 as comprised in the PMC based on a corresponding decision tree. In such cases, the obtaining process as described with reference to block 202 can comprise a generation process of the restructured tree, as will be described below with reference to FIG. 3.

Referring now to FIG. 3, there is illustrated a generalized flowchart of generating a restructured tree based on a corresponding decision tree in accordance with certain embodiments of the presently disclosed subject matter.

Each given non-leaf node in the decision tree can be duplicated (302) (e.g., by the Decision tree restructuring module 104 as comprised in the PMC) according to the number of leaf nodes linked thereto, giving rise to a set of duplicated non-leaf nodes corresponding to the given non-leaf node. Each duplicated non-leaf node in the set can be associated with a respective duplicated condition based on the condition comprised in the conditional test associated with the given non-leaf node. The respective duplicated condition associated with each duplicated non-leaf node in the set can comprise the same operator as comprised in the condition (i.e., the condition comprised in the conditional test associated with the corresponding given non-leaf node) or an opposite operator. The purpose of the duplication is to “flatten” the tree into paralleled paths which cover all possible branching options.

Specifically, in order to cover all possible branching from a given non-leaf node downwards (i.e., towards the leaf nodes), half duplicated non-leaf nodes in each set of duplicated non-leaf nodes have duplicated conditions associated therewith that comprise the same operator as the one comprised in the condition, and the other half in the set have duplicated conditions associated therewith that comprise the opposite operator that is opposite to the one comprised in the condition. The operator referred herein can be any operator that is capable of enabling the conditional test to produce binary results. For example, the operator can be a comparison operator, such as “>” or “<” etc. In some cases, the operator can also refer to a combination of operators that can also be used to yield binary results, such as, e.g., a combination of a comparison operator with one of the following: arithmetic operator(s), logical operator(s), etc.

Upon duplication being completed for all non-leaf nodes in the decision tree, there are provided a plurality of sets of duplicated non-leaf nodes corresponding to a plurality of non-leaf nodes in the decision tree.

All operators as comprised in respective duplicated conditions associated with all duplicated non-leaf nodes in the plurality of sets of duplicated non-leaf nodes can be unified (304) (e.g., by the Decision tree restructuring module 104) to a common operator. The unification can be performed by modifying one or more operators, from all operators, that are opposite to the common operator, to the common operator. A restructured tree is thereby generated.

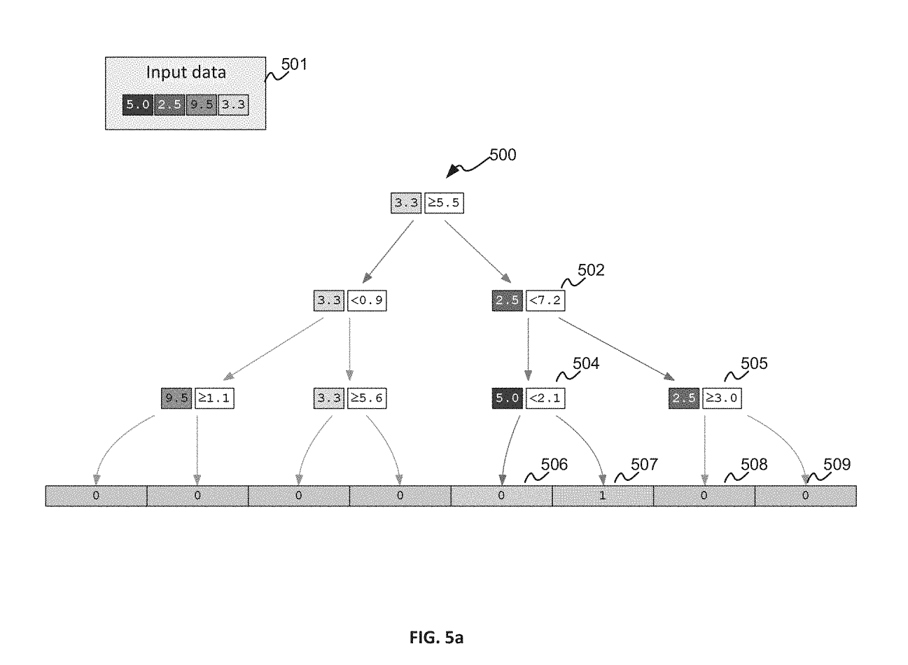

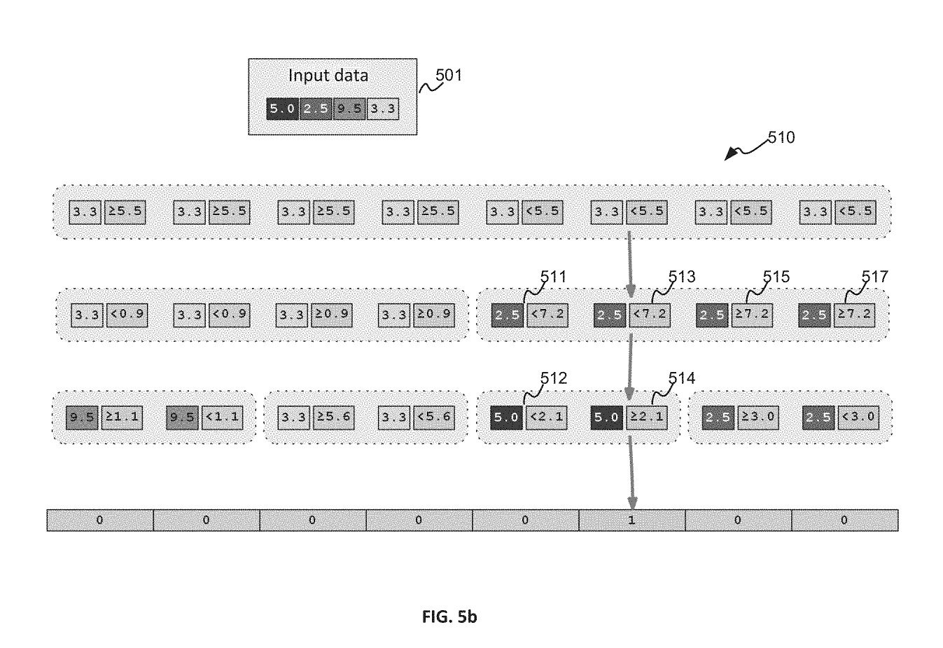

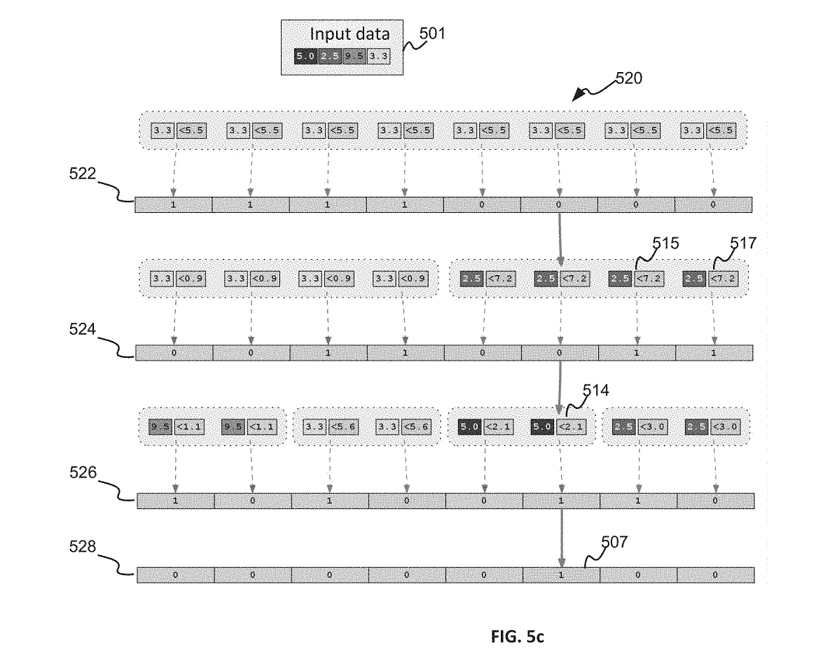

For exemplary purposes, reference is now made to FIGS. 5a to 5c which illustrate an example of a decision tree and a corresponding restructured tree generated therefrom in accordance with certain embodiments of the presently disclosed subject matter.

FIG. 5a illustrates an example of a decision tree 500. The decision tree 500 is exemplified as a symmetric binary tree in which each non-leaf node has two branches (i.e., two subsequent connections). The decision tree 500 comprises four layers, in which the first three layers comprise non-leaf nodes and the last layer comprises leaf nodes. It is to be appreciated that the present disclosure is not limited to a specific structure of the decision tree, such as, e.g., whether the decision tree is symmetric or not. Accordingly in some cases, a given layer in a decision tree can comprise both non-leaf node(s) and leaf node(s).

As shown, each non-leaf node in decision tree 500 is associated with a binary conditional test that has two possible results (in this case, true or false). The binary conditional test is a test of a condition capable of receiving a specific given component from the four components so as to be applied on the received component. For instance, non-leaf node 502 is associated with a conditional test in which the condition is “a specific input component to be received is smaller than 7.2”. The conditional test is thus “is a specific input component to be received smaller than 7.2?”. The operator comprised in the condition is a comparison operator “<”. The non-leaf node 502 is connected to two subsequent nodes 504 and 505 in a subsequent layer in accordance with the respective “true” and “false” results of the conditional test.

In the present example, the decision tree 500 is used to classify an input object which is represented by input data 501. Input data 501 comprises four components which are illustrated as four numerical values 5.0, 2.5, 9.5 and 3.3. Each non-leaf node (or the conditional test associated therewith) in the decision tree 500 is capable of receiving a specific input component from the four components so that the conditional test can be applied on the received component. For instance, the input component to be received by the non-leaf node 502 is 2.5 (i.e., the second component of the input data). The conditional test, when applied on the input component, becomes “is 2.5 smaller than 7.2?”, of which the result is “true” (i.e., the left branch as illustrated). Therefore, upon receiving input data and feeding the appropriate components to each non-leaf node, starting from the root node, for each non-leaf node, the conditional test associated therewith is applied to the received component thereof and an appropriate branch is selected based on the result of the test. The branch either leads to another non-leaf node, for which a corresponding conditional test is applied, or to a leaf node. When a leaf node is reached, the class associated with the leaf node is then assigned to the input object represented by the input data. In the example illustrated in FIG. 5a, the leaf node 507 that has a value of “1” indicates the class of the input object.

FIG. 5b illustrates an example of an intermediate restructured tree 510. As shown, each non-leaf node in the decision tree 500 is duplicated into a set of duplicated non-leaf nodes (also referred to as duplicated nodes) according to the number of leaf nodes linked thereto, as described above with reference to block 302. The linkage between the given non-leaf node and the linked leaf nodes thereof can be either direct or indirect. By way of example, the non-leaf node 504 is duplicated to a set of duplicated non-leaf nodes which include two duplicated non-lead nodes 512 and 514. This is because non-leaf node 504 is linked to (in this case a direct linkage) two leaf nodes 506 and 507 which indicates two possible branching options based on results of the conditional test (i.e., a specific input component to be received at this node is either smaller than or not smaller than 2.1). Specifically, duplicated node 512 is associated with a duplicated condition of “a specific input component to be received is smaller than 2.1” which thus comprises the same operator “<” as comprised in the condition of non-leaf node 504, while node 514 is associated with a duplicated condition of “a specific input component to be received is bigger than or equal to 2.1” which comprises the opposite operator “≥”.

By way of another example, the non-leaf node 502 is duplicated to a set of duplicated non-leaf nodes which include four duplicated non-lead nodes 511, 513, 515 and 517. Similarly, this is in accordance with the fact that non-leaf node 502 is linked to (in this case an indirect linkage) four leaf nodes 506, 507, 508 and 509 which indicates four possible branching options from this node 502 downwards (i.e., towards the leaf nodes). Specifically, duplicated nodes 511 and 513 (i.e., half of the nodes in the set) are both associated with a duplicated condition of “a specific input component to be received is smaller than 7.2” which comprises the same operator “<” as comprised in the condition of non-leaf node 502, so as to cover the two branching options of node 504, while duplicated nodes 515 and 517 (i.e., the other half of the nodes in the set) are associated with a duplicated condition of “a specific input component to be received is bigger than or equal to 7.2” which comprises the opposite operator “≥”, so as to cover the two branching options of node 505.

Once the duplication for all non-leaf nodes is done, the intermediate restructured tree 510 is generated. It is to be noted that in some cases the duplication for the non-leaf nodes can be performed bottom-up (i.e., from the most bottom layer that comprises non-leaf nodes up), but this is not necessarily so. As long as the number of linked leaf nodes of each non-leaf node is known, the duplication for the non-leaf nodes can be performed from top to bottom, or in a concurrent manner if the processor supports such processing. As shown, the intermediate restructured tree 510 is a flattened tree in the sense that in each layer there is an equal number of nodes (i.e., the same as the number of leaf nodes).

FIG. 5c illustrates an example of a restructured tree 520 generated based on the intermediate restructured tree 510. The difference between tree 520 and tree 510 is that, all operators as comprised in respective duplicated conditions associated with all duplicated non-leaf nodes in the plurality of sets of duplicated non-leaf nodes in tree 520 are unified to a common operator (in this case “<”), whereas in tree 510 some of the operators are “<” and the others are “≥”. This unification is performed, as described above with reference to block 304, by modifying the operators (in this case “?”) that are opposite to the common operator to the common operator. For instance, the operators of “≥” which were originally comprised in duplicated nodes 514, 515 and 517 (among others), after the duplication (as illustrated in FIG. 5b), are now modified/switched to “<” (as illustrated in FIG. 5c). Therefore, not only within each layer of the restructured tree 520, but between layers among the entire tree, there is used a single unified operator in all the duplicated conditions, which enables flexible parallel processing by a processor with such capability (such as, e.g., the processor that supports SIMD, or GPU as aforementioned).

According to certain embodiments, the modified operators (i.e., the duplicated nodes in which the operators are switched) are all marked by way of an inversion mask so as to be used in a later process to correct the computation results as affected by the modification, as will be described below with reference to block 206.

Continuing with the description of FIG. 2, appropriate components selected from the plurality of components can be provided/fed (204) (e.g., by the Input feeding module 106) to corresponding duplicated non-leaf nodes of each given layer to be used in the duplicated condition associated thereof.

As described above, one factor that may cause the low performance of the classification system is that the plurality of components of the input data can be possibly placed in different locations in memory which cannot be loaded by a single instruction. Therefore, in order to provide appropriate components for each non-leaf node, memory needs to be accessed multiple times for fetching each of the components and writing back the computation results of each non-leaf node afterwards. This can be time consuming and in some cases may cause unnecessary delay or stall of processing. To address this issue, another aspect of the present disclosure is to provide an efficient way of fetching and feeding required input components to respective non-leaf nodes so as to increase the CPU throughput and avoid unnecessary delay of processing.

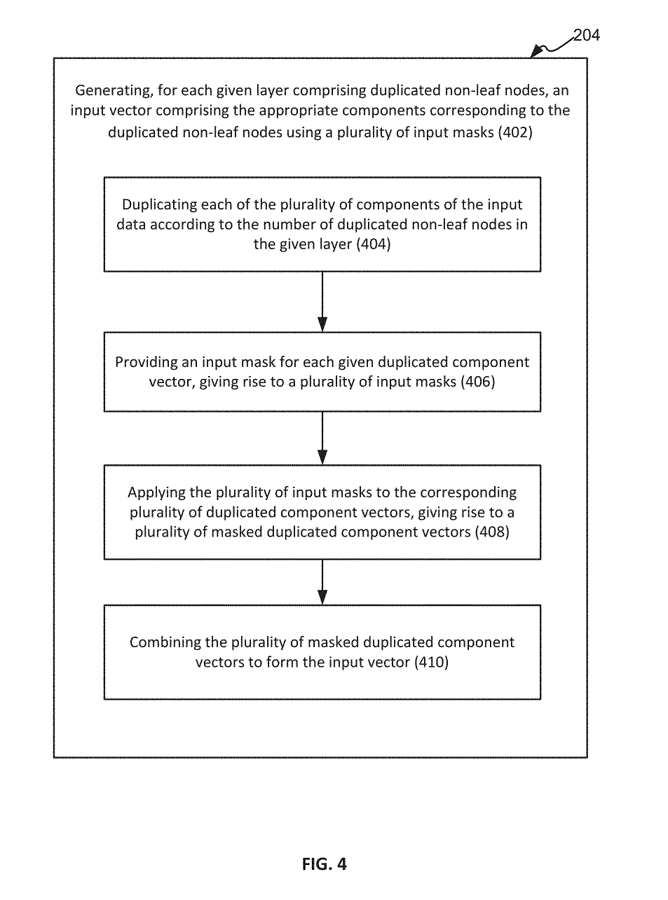

Referring now to FIG. 4, there is illustrated a generalized flowchart of providing appropriate components to corresponding duplicated non-leaf nodes of each given layer, as described with reference to block 204, in accordance with certain embodiments of the presently disclosed subject matter.

The providing of appropriate components can be performed by generating (402) (e.g., by the Input feeding module 106), for each given layer comprising duplicated non-leaf nodes, an input vector comprising the appropriate components corresponding to the duplicated non-leaf nodes using a plurality of input masks.

According to certain embodiments, the generation of an input vector for each given layer can comprise the following processes: duplicating (404) each of the plurality of components of the input data according to the number of duplicated non-leaf nodes in the given layer, giving rise to a plurality of duplicated component vectors; providing (406) an input mask for each given duplicated component vector according to the position of one or more duplicated non-leaf nodes in the given layer, the one or more duplicated non-leaf nodes associated with a duplicated condition applied on the component comprised in the given duplicated component vector, giving rise to a plurality of input masks corresponding to the plurality of duplicated component vectors; applying (408) the plurality of input masks to the corresponding plurality of duplicated component vectors, giving rise to a plurality of masked duplicated component vectors; and combining (410) the plurality of masked duplicated component vectors to form the input vector.

For purpose of illustration, there is now provided an example of generating an input vector corresponding to a given input data which takes the form of a vector of 4 components, for example: [55, 7, 21, 19]. Assume a given layer of the restructured tree comprises eight nodes represented by: (1) (1) (0) (1) (3) (2) (3) (0). The numbers 0-3 indicate the positions/indices of components of the input data which each corresponding node and the associated condition thereof require to receive. For instance, the selected input component for the first, second and fourth nodes in the given layer is component 1 (i.e., the second component) of the input data, which is “7”. Similarly, the selected input component for the third and eighth nodes in the given layer is component 0 (i.e., the first component) of the input data, which is “55”. It is to be noted that the above given layer with such indices is provided for exemplary and illustrative purposes only. Different restructured trees can have different indices in layers depending on the structure thereof.

According to the proposed method described with reference to FIG. 4, each of the four components of the input data is duplicated (404) according to the number of duplicated non-leaf nodes in the given layer (e.g., eight in the present case). The four duplicated component vectors generated are as follows:
[55, 55, 55, 55, 55, 55, 55, 55]
[7, 7, 7, 7, 7, 7, 7, 7]
[21, 21, 21, 21, 21, 21, 21, 21]
[19, 19, 19, 19, 19, 19, 19, 19]

An input mask is provided (406) for each given duplicated component vector according to the positions/indices of the duplicated non-leaf nodes in the given layer that are associated with a duplicated condition to be applied on the component comprised in the given duplicated component vector. For instance, for the first duplicated component vector [55, 55, 55, 55, 55, 55, 55, 55], since the nodes that require to receive the component “55” are the third and eighth nodes in the given layer, the input mask generated for the first duplicated component vector should be [0, 0, 1, 0, 0, 0, 0, 1] which indicates the positions/indices of such nodes. Similarly, respective input masks are generated for the other three duplicated component vectors, thereby giving rise to four input masks corresponding to the four duplicated component vectors:
For 1st duplicated component vector: [0, 0, 1, 0, 0, 0, 0, 1]
For 2nd duplicated component vector: [1, 1, 0, 1, 0, 0, 0, 0]
For 3rd duplicated component vector: [0, 0, 0, 0, 0, 1, 0, 0]
For 4th duplicated component vector: [0, 0, 0, 0, 1, 0, 1, 0]

It is to be noted that the plurality of input masks can be pre-prepared (e.g., either by the PMC 102, or by an external source which is operatively connected to system 100) according to the structure of the restructured tree, before the classification of an input object begins. Upon receiving a specific input object and representative input data thereof, the pre-prepared input masks can be retrieved, e.g., from the storage unit, and provided to the Input feeding module 106 to be used for generating the input vectors and feeding the input components to respective duplicated non-leaf nodes. Alternatively, the step as described with reference to block 406 can further comprise the generation of the input masks in a manner as described above.

Upon obtaining the four input masks, the input masks are applied (408) to the corresponding duplicated component vectors. A logical operation “AND” can be applied between an input mask and a corresponding duplicated component vector to generate a corresponding masked duplicated component vector. For instance, applying “AND” between the first input mask [0, 0, 1, 0, 0, 0, 0, 1] and the first duplicated component vector [55, 55, 55, 55, 55, 55, 55, 55] can give rise to the first masked duplicated component vector [0, 0, 55, 0, 0, 0, 0, 55]. Accordingly, the four masked duplicated component vectors are as follows:
[0, 0, 55, 0, 0, 0, 0, 55]
[7, 7, 0, 7, 0, 0, 0, 0]
[0, 0, 0, 0, 0, 21, 0, 0]
[0, 0, 0, 0, 19, 0, 19, 0]

The four masked duplicated component vectors are combined (410) to form the input vector for the given layer. A logical operation “OR” can be applied between the four masked duplicated component vectors, and an input vector [7, 7, 55, 7, 19, 21, 19, 55] is generated, which comprises appropriate components corresponding to respective duplicated non-leaf nodes in the given layer, and can be provided/fed to the corresponding duplicated non-leaf nodes of the given layer to be used in the duplicated condition associated thereof. In some embodiments where the processor supports SIMD, the input vector can be also referred to as an SIMD vector, which can be supplied to a SIMD register, as will be described in further detail below.

The process as described with reference to FIG. 4 can be repeated for each layer of the restructured tree, thereby generating respective input vectors for all the layers that comprise duplicated non-leaf nodes and providing the generated input vectors to corresponding layers such that each duplicated non-leaf node in the restructured tree can receive appropriate input component. By using the teaching of FIG. 4, the appropriate components for a given layer can be possibly retrieved all in one go (depending on the width of the register) thereby avoiding the multiple times of memory access and increasing the throughput and efficiency of the classification.

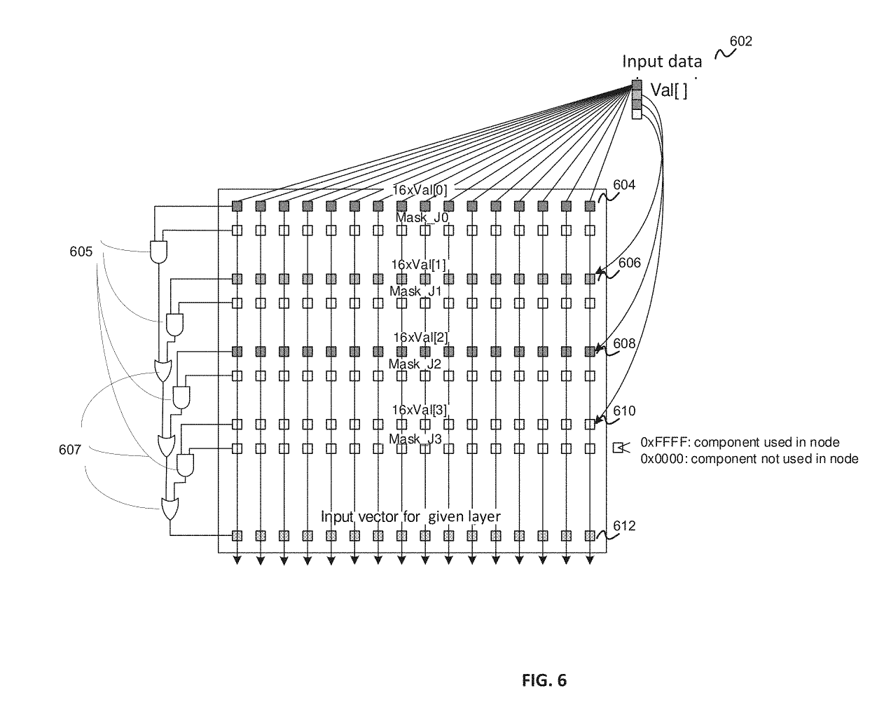

FIG. 6 is a schematic illustration of an exemplified implementation of the generation of an input vector for a given layer in accordance with certain embodiments of the presently disclosed subject matter.

As shown, the input data 602 comprises four components Val [0]-Val [3]. In the present example, assuming the given layer comprises 16 duplicated non-leaf nodes, each component is accordingly duplicated into a 16-component duplicated component vector according to the description with reference to block 404, thereby giving rise to four duplicated component vectors 604, 606, 608 and 610. Four corresponding input masks (marked as Mask_J0-Mask_J3 in the figure) are provided for respective duplicated component vectors according to the description with reference to block 406. Specifically, the input mask can indicate position of nodes in the given layer that receive a relevant component (e.g., by setting the values in the corresponding positions of the input mask as 1). An “AND” operation (illustrated as an “AND” logic gate 605) is applied between each input mask and corresponding duplicated component vector to obtain a masked duplicated component vector. And an “OR” operation (illustrated as an “OR” logic gate 607) is applied between the four masked duplicated component vectors to generate the input vector 612 for the given layer.

Referring back to FIG. 2, once appropriate components for respective duplicated non-leaf nodes in the restructured tree are provided, for each given layer of the restructured tree that comprises duplicated non-leaf nodes, a per layer output can be generated (206) (e.g., by the Per layer output generation module 108) by applying the duplicated condition associated with each duplicated non-leaf node in the given layer on the corresponding appropriate component. An inversion mask can be applied to the per layer output to obtain a corrected per layer output, thereby giving rise to a plurality of corrected per layer outputs.

As aforementioned, when the unification of operators are performed, as described with reference to block 304, some operators that are opposite to the common operator are modified so as to be able to utilize the parallel processing capabilities of the processor. It is understandable that when an operator is modified (i.e., switched to the opposite), the computation result of the duplicated condition associated with the duplicated non-leaf node in which the operator is modified would be modified as well (i.e., switched/inverted to the opposite of what it is supposed to be). In some embodiments, in order to get the expected original results, the modified operators are all marked by way of an inversion mask so as to be used to correct the computation results as affected by the modification. The marking of the modified operators can be done by providing an inversion mask for each given layer based on one or more modified operators in the given layer. By way of example, for a duplicated non-leaf node in which the operator (i.e., the operator in the duplicated condition associated with the duplicated non-leaf node) is modified, a corresponding position in the inversion mask can be set with, e.g., a value of 1, and for a duplicated non-leaf node in which the operator is not modified, a corresponding position in the inversion mask can be set with, e.g., a value of 0. An inversion mask can be provided in the form of a vector, a list or any other suitable representative formats.

In some embodiments, the inversion mask can be applied to the per layer output by performing a XOR operation between the inversion mask and the per layer output in order to obtain the corrected per layer output. A logical operation XOR gives a true (e.g., 1) output when the number of true inputs (e.g., 1) is odd. Therefore, for positions which are marked as “1” in the inversion mask, if the result from the duplicate condition is 1 (while the original result before modification is supposed to be 0), the corrected output after the XOR would be 0; otherwise if the result from the duplicate condition is 0 (while the original result before modification is supposed to be 1), the corrected output would be 1. For positions which are marked as “0” in the inversion mask, the corrected per layer output would be the same as the per layer output. Therefore, the goal of correcting the per layer output is achieved by using these inversion masks.

Referring back to FIG. 5c, inversion masks 522, 524 and 526 are provided respectively for the first three layers of the restructured tree 520. To continue with previous examples, as described above, the operators of “≥” which were originally comprised in duplicated non-leaf nodes 514, 515 and 517 (among others) were modified/switched to “<” (as illustrated in FIG. 5c). Accordingly, corresponding positions in the inversion mask for these nodes are set with a value of 1. By way of example, for duplicated non-leaf node 514, the result of the duplicated condition “5.0<2.1” is false (e.g., 0) (while the original result before modification of the operator thereof is supposed to be 1), and after applying the inversion mask, the corrected result is modified to be 1 which reflects the expected original result. Similarly, the results of all the duplicated conditions in which the operators are modified are corrected in the same manner. The results of nodes per layer (constituting the per layer outputs) and corrected results of nodes per layer (constituting the corrected per layer outputs) are not illustrated in the figure for the purpose of conciseness.

It is to be noted that the inversion masks can be pre-prepared (e.g., either by the PMC 102, or by an external source which is operatively connected to system 100) according to the modified operators in the restructured tree, before the classification of an input object begins And upon receiving a specific input object and representative input data thereof, the pre-prepared inversion masks can be retrieved, e.g., from the storage unit, and provided to the Per layer output generation module 108 to be used for generating corrected per layer outputs. Alternatively, the step as described with reference to block 206 can further comprise the generation of the inversion masks in a manner as described above.

Continuing with the description of FIG. 2, the plurality of corrected per layer outputs can be combined (208) (e.g., by the Classification module 110), giving rise to the classification of the object. In one embodiment, the combination of the plurality of corrected per layer outputs can be performed by applying an AND operation among the plurality of corrected per layer outputs to obtain a combined output. FIG. 5c shows the combined output 528 which corresponds to the leaf nodes. As illustrated, the leaf node 507 that has the value of 1 indicates the class/category of the input object.

As described above, in some embodiments, the input object can be a first pixel group comprising one or more pixels from an input image. The classification of the first pixel group can be indicative of a category/class thereof. By way of example, the class/category can indicate whether the pixel group represents a specific texture, such as, e.g., skin, grass, face, sky, gravel, parquet, image with high film grain, etc. In some cases, processes as described with reference to blocks 204, 206 and 208 can be repeated for one or more subsequent pixel groups of the input image, thereby giving rise to classification of each of the one or more subsequent pixel groups. Additionally, a classification of the input image, or of a segment thereof, can be provided based on the classification of the pixel groups in the input image (e.g., classification of the first pixel group and each of the one or more subsequent pixel groups).

In some embodiments, such classification information (classification of the first pixel group and/or classification of the input image, or of a segment thereof) can be used for facilitating/optimizing the encoding of the input image or part thereof and/or quality evaluation of the encoded content. In some embodiments, the classification information can be used to configure (e.g., by the Configurator 112) an encoder (e.g., the Encoder 114) and/or a quality evaluation unit (e.g., the Quality evaluation unit 116), by way of, e.g., providing configuration instruction(s). By way of example, possible configuration of the encoder can include one or more of the following: instructing a rate control module to allocate more or less bits to a certain area in a video frame or to certain video frames according to the classification thereof; configuring encoder parameters such as Quantization Parameter, or various encoder decisions such as but not limited to encoding modes, partitioning decisions or deblocking filter strength according to the classification of a frame or a segment thereof, etc. Possible configuration of the quality evaluation unit can include one or more of the following: configuring thresholds or weights used in quality measure calculation according to the class of the frame or a segment thereof. For example, in a quality measure incorporating a texture component (such as described in U.S. Pat. No. 9,491,464 entitled “Controlling a video content system by computing a frame quality score” issued on Nov. 8, 2016, which is incorporated herein in its entirety by reference, as well as described in U.S. Pat. No. 8,908,984 entitled “Apparatus and Methods for Recompression of Digital Images” issued on December, 2014, which is incorporated herein in its entirety by reference), stricter thresholds may be used for texture preservation in an area of the frame classified as skin.

It is to be noted that the processor(s) used herein for performing the classification of an object as described with reference to FIG. 2 refers to a specially configured processor(s)/computer(s) capable of parallel processing, such as processor(s) that support SIMD schemes, or processor(s) that specialize in graphical processing (e.g., GPU), etc. For instance, processors supporting SIMD (also referred to herein as SIMD processors) comprise multiple processing elements that perform the same operation/instruction on multiple data points simultaneously. Thus, such processors are able to exploit data level parallelism, i.e., simultaneous (parallel) computations, but only a single instruction at a given moment.

Certain embodiments of the presently disclosed subject matter are adapted to take advantage of the SIMD scheme thereby improving performance of the classification system. By way of example, one improvement is that, by utilizing a “flattened” structure of the restructured tree, a common operation/instruction (e.g., enabled by the unification of operators to a common operator) can operate on multiple data points (e.g., enabled by duplication of non-leaf nodes to multiple duplicated non-leaf nodes associated with duplicated conditions) at one time. By way of example, if a SIMD processor works by loading up eight data points at one time, the common operation being applied to the data will occur to all eight values at the same time. It is to be noted that this parallelism, which is data level parallelism, is separate from the instruction level parallelism which can be provided by a superscalar processor and/or instruction pipelining. The eight values are processed in parallel even on a processor which is not capable of instruction level parallelism. Thus, in some cases, a processor may be configured to exploit both data level parallelism and instruction level parallelism by performing multiple SIMD operations in parallel.

Another improvement achieved by certain embodiments of the presently disclosed subject matter is that, by utilizing the SIMD scheme, as well as the proposed method of providing appropriate components to duplicated non-leaf nodes by way of input vectors, multiple values (e.g., components) can be effectively retrieved/loaded all at one time through a single instruction, instead of a series of operations of “retrieve the first component, now retrieve the next component, etc.”. This can take much less time than retrieving each component individually, as with traditional approaches.

In certain embodiments, each or at least one of the providing appropriate components to corresponding duplicated non-leaf nodes, the applying the duplicated condition on the corresponding appropriate component, the applying an inversion mask to the per layer output and the combining the plurality of corrected per layer outputs is performed, by a SIMD processor, in parallel for at least part of the duplicated non-leaf nodes in the given layer.

In certain embodiments, a SIMD processor can comprise a plurality of multi-component registers (also referred to as vector registers or SIMD registers or registers) each having a fixed width. In some cases, the fixed width of a register is capable of holding data corresponding to at least one layer of at least one restructured tree. The data corresponding to the at least one layer can be packed/loaded into the plurality of multi-component registers and processed by the processor in parallel. Continuing with the example of the restructured tree 520 which comprises eight nodes per layer, assuming each input component can be described by 16 bits (e.g., unsigned short), and the width of a SIMD register is restricted by 128 bits (8 short values), in such cases, data corresponding to the eight components of the nodes (which can be held, e.g., in the input vector as described above) in a given layer of the restructured tree 520 can be exactly packed into a first SIMD register, and data corresponding to the operands comprise in the duplicated conditions in the given layer can be packed into a second SIMD register. The common operation “<” between respective components and operands for the eight nodes can be performed by the processor in parallel. In some cases, if the fixed width of a SIMD register is larger and can hold data corresponding to more than one layer of the restructured tree, the data corresponding to the more than one layer can be packed into the registers and can be processed in parallel.

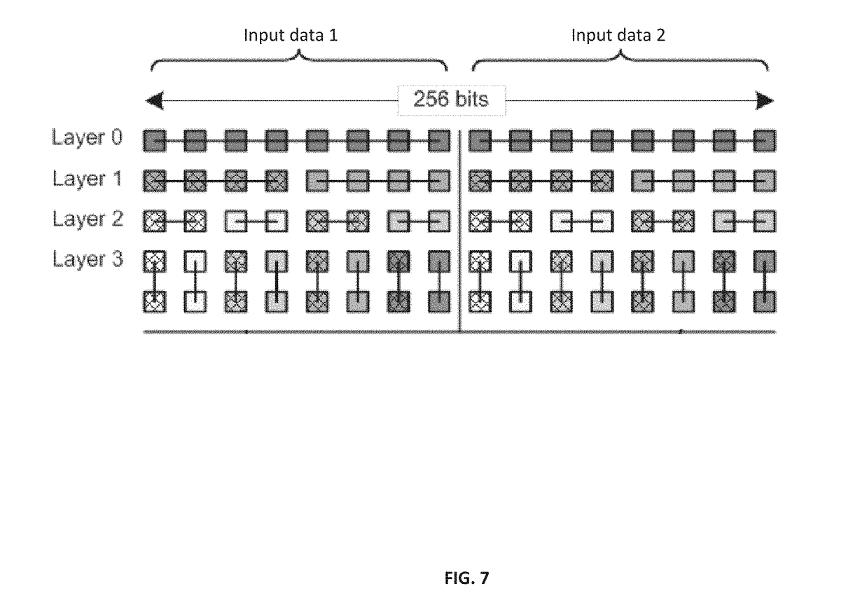

Referring now to FIG. 7, there is illustrated a schematic illustration of exemplified registers holding data corresponding to layers from two restructured trees in accordance with certain embodiments of the presently disclosed subject matter. The illustrated SIMD registers are restricted by 256 bits (16 short values). For a restructured tree similar to the tree 520, each of such registers can hold data corresponding to two layers (e.g., one register can hold data corresponding to 16 input components, and another can hold data corresponding to 16 operands), which can be either two layers from the same tree, or each layer from a different tree. In the example shown in FIG. 7, layers from two restructured trees for classifying two input objects represented by input data 1 and 2 are packed into the registers and processed in parallel.

On the other hand, if data corresponding to each layer of the restructured tree exceeds the fixed width of the registers, the restructured tree can be divided into a plurality of sub-trees such that at least one sub-tree of the plurality of sub-trees can utilize the fixed width at one time. Data corresponding to at least one layer from at least one sub-tree can be packed into the plurality of multi-component registers and processed by the processor in parallel. Continuing with the above example of the restructured tree 520, assuming the fixed width of a SIMD register is restricted by 96 bits (6 short values), only 6 input components can be packed into the register at one time. The restructured tree 520 can be divided into two sub-trees: the first one with the first six nodes in all layers, and the second one with the last two nodes in all layers. Data corresponding to each layer of the first sub-tree can be packed into the registers and processed in parallel. The second sub-tree can be combined with, for instance, one or more sub-trees from another restructured tree, in order to utilize the full width of the registers. It is to be noted that the present disclosed subject matter can also be used in cascading classifiers which is a concatenation of several classifiers. In some cases, the cascading classifier can be divided into a suitable number of sub-trees in order to utilize the parallel processing ability of the proposed approach.

It is appreciated that the examples and embodiments illustrated with reference to the SIMD registers, structures of restructured trees and division of sub-trees in the present description are by no means inclusive of all possible alternatives but are intended to illustrate non-limiting examples only.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer readable memory or storage medium tangibly embodying a program of instructions executable by the computer for executing the method of the invention.

The non-transitory computer readable storage medium causing a processor to carry out aspects of the present invention can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Those skilled in the art will readily appreciate that various modifications and changes can be applied to the embodiments of the invention as hereinbefore described without departing from its scope, defined in and by the appended claims.

1. A non-transitory computer readable medium comprising:
data representative of a restructured tree corresponding to a decision tree, the restructured tree usable for classifying an object represented by input data comprising a plurality of components;
wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test; and
wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree.

2. A non-transitory computer readable medium of claim 1, wherein the restructured tree is usable by a processor capable of parallel processing for performing the classifying an object.

3. A computerized system capable of classifying an object represented by input data comprising a plurality of components, the system comprising a processing and memory circuitry (PMC) capable of parallel processing and configured to:
i) obtain a restructured tree corresponding to a decision tree, wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test, and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree;
ii) provide appropriate components selected from the plurality of components to corresponding duplicated non-leaf nodes of each given layer to be used in the duplicated condition associated thereof;
iii) for each given layer of the restructured tree that comprises duplicated non-leaf nodes, generate a per layer output by applying the duplicated condition associated with each duplicated non-leaf node on the corresponding appropriate component, and apply an inversion mask to the per layer output to obtain a corrected per layer output, giving rise to a plurality of corrected per layer outputs; and
iv) combine the plurality of corrected per layer outputs giving rise to the classification of the object.

4. The system according to claim 3, wherein the object is a first pixel group comprising one or more pixels from an input image, and the input data comprises a plurality of components corresponding to the first pixel group, and wherein the classification of the first pixel group is indicative of a category thereof.

5. The system according to claim 4, wherein the plurality of components are selected from a group comprising luma and chroma components and one or more components derived from pixel values of the one or more pixels in the first pixel group and adjacent pixels thereto.

6. The system according to claim 4, wherein the PMC is further configured to repeat said ii)-iv) for one or more subsequent pixel groups of the input image, thereby giving rise to classification of each of the one or more subsequent pixel groups.

7. The system according to claim 6, wherein the PMC is further configured to provide classification of the input image based on the classification of the first pixel group and each of the one or more subsequent pixel groups.

8. The system according to claim 3, wherein the restructured tree is generated by:
a) duplicating each given non-leaf node in the decision tree according to the number of leaf nodes linked thereto, giving rise to a set of duplicated non-leaf nodes corresponding to the given non-leaf node, and associating each duplicated non-leaf node in the set with a respective duplicated condition based on the condition comprised in the conditional test associated with the given non-leaf node, wherein the respective duplicated condition comprises the same operator as comprised in the condition or an opposite operator, thereby providing a plurality of sets of duplicated non-leaf nodes corresponding to a plurality of non-leaf nodes in the decision tree; and
b) unifying all operators as comprised in respective duplicated conditions associated with all duplicated non-leaf nodes in the plurality of sets of duplicated non-leaf nodes to a common operator by modifying one or more operators thereof that are opposite to the common operator, giving rise to the restructured tree.

9. The system according to claim 8, wherein the applying an inversion mask comprises providing an inversion mask for each given layer based on one or more modified operators in the given layer, and applying the inversion mask by performing an XOR operation between the inversion mask and the per layer output to obtain the corrected per layer output.

10. The system according to claim 3, wherein the PMC is configured to provide appropriate components by generating, for each given layer comprising duplicated non-leaf nodes, an input vector comprising the appropriate components corresponding to the duplicated non-leaf nodes using a plurality of input masks.

11. The system according to claim 10, wherein the generating an input vector comprises:
duplicating each of the plurality of components of the input data according to the number of duplicated non-leaf nodes in the given layer, giving rise to a plurality of duplicated component vectors;
providing an input mask for each given duplicated component vector according to position of one or more duplicated non-leaf nodes in the given layer, the one or more duplicated non-leaf nodes associated with a duplicated condition to be applied on the component comprised in the given duplicated component vector, giving rise to a plurality of input masks corresponding to the plurality of duplicated component vectors;
applying the plurality of input masks to the corresponding plurality of duplicated component vectors, giving rise to a plurality of masked duplicated component vectors; and
combining the plurality of masked duplicated component vectors to form the input vector.

12. The system according to claim 3, wherein the PMC is configured to combine the plurality of corrected per layer outputs by applying an AND operation among the plurality of corrected per layer outputs.

13. The system according to claim 3, wherein the PMC comprises a processor supporting SIMD and wherein at least one of the providing appropriate components to corresponding duplicated non-leaf nodes, the applying the duplicated condition on the corresponding appropriate component, the applying an inversion mask to the per layer output and the combining the plurality of corrected per layer outputs is performed, by the processor, in parallel for at least part of duplicated non-leaf nodes in the given layer.

14. The system according to claim 3, wherein the PMC comprises a processor supporting SIMD and comprising a plurality of multi-component registers each having a fixed width and data corresponding to each layer of the restructured tree exceeds the fixed width, and wherein the restructured tree is divided into a plurality of sub-trees such that at least one sub-tree of the plurality of sub-trees utilizes the fixed width.

15. The system according to claim 3, wherein the PMC comprises a processor supporting SIMD and comprising a plurality of multi-component registers each having a fixed width capable of holding data corresponding to at least one layer of at least one restructured tree, and wherein the data is packed into the plurality of multi-component registers and processed by the processor in parallel.

16. The system according to claim 14, wherein data corresponding at least one layer from at least one sub-tree is packed into the plurality of multi-component registers and processed by the processor in parallel.

17. A computerized method of classification of an object represented by input data comprising a plurality of components, the method performed by a processor capable of parallel processing and comprising:
i) obtaining a restructured tree corresponding to a decision tree, wherein the decision tree comprises a plurality of layers each comprising one or more nodes, each node in the decision tree being a leaf node or non-leaf node, each given non-leaf node being associated with a binary conditional test, the binary conditional test being a test of a condition capable of receiving a given component of the plurality of components of the input data so as to be applied on the given component, the condition comprising an operator, the given non-leaf node connected to two subsequent nodes in a subsequent layer in accordance with possible results of the conditional test, and wherein the restructured tree comprises a plurality of sets of duplicated non-leaf nodes corresponding to a plurality of non-leaf nodes in the decision tree, each set of duplicated non-leaf nodes duplicated from a corresponding non-leaf node according to the number of leaf nodes linked thereto, each given duplicated non-leaf node in the plurality of sets of duplicated non-leaf nodes being associated with a respective duplicated condition, the respective duplicated condition being duplicated based on the condition comprised in the conditional test associated with the corresponding non-leaf node and comprising a common operator that is common in all duplicated conditions associated with respective duplicated non-leaf nodes in the restructured tree;
ii) providing appropriate components selected from the plurality of components to corresponding duplicated non-leaf nodes of each given layer to be used in the duplicated condition associated thereof;
iii) for each given layer of the restructured tree that comprises duplicated non-leaf nodes, generating a per layer output by applying the duplicated condition associated with each duplicated non-leaf node on the corresponding appropriate component, and applying an inversion mask to the per layer output to obtain a corrected per layer output, giving rise to a plurality of corrected per layer outputs; and
iv) combining the plurality of corrected per layer outputs giving rise to the classification of the object.

18. The method according to claim 17, wherein the object is a first pixel group comprising one or more pixels from an input image, and the input data comprises a plurality of components corresponding to the first pixel group, and wherein the classification of the first pixel group is indicative of a category thereof.

19. The method according to claim 18, wherein the plurality of components are selected from a group comprising luma and chroma components and one or more components derived from pixel values of the one or more pixels in the first pixel group and adjacent pixels thereto.

20. The method according to claim 18, further comprising repeating said steps ii)-iv) for one or more subsequent pixel groups of the input image, thereby giving rise to classification of each of the one or more subsequent pixel groups.

21. The method according to claim 20, further comprising providing classification of the input image based on the classification of the first pixel group and each of the one or more subsequent pixel groups.

22. The method according to claim 17, wherein the restructured tree is generated by:
a) duplicating each given non-leaf node in the decision tree according to the number of leaf nodes linked thereto, giving rise to a set of duplicated non-leaf nodes corresponding to the given non-leaf node, and associating each duplicated non-leaf node in the set with a respective duplicated condition based on the condition comprised in the conditional test associated with the given non-leaf node, wherein the respective duplicated condition comprises the same operator as comprised in the condition or an opposite operator, thereby providing a plurality of sets of duplicated non-leaf nodes corresponding to a plurality of non-leaf nodes in the decision tree; and
b) unifying all operators as comprised in respective duplicated conditions associated with all duplicated non-leaf nodes in the plurality of sets of duplicated non-leaf nodes to a common operator by modifying one or more operators thereof that are opposite to the common operator, giving rise to the restructured tree.

23. The method according to claim 22, wherein the applying an inversion mask comprises providing an inversion mask for each given layer based on one or more modified operators in the given layer, and applying the inversion mask by performing an XOR operation between the inversion mask and the per layer output to obtain the corrected per layer output.

24. The method according to claim 17, wherein the providing appropriate components is performed by generating, for each given layer comprising duplicated non-leaf nodes, an input vector comprising the appropriate components corresponding to the duplicated non-leaf nodes using a plurality of input masks.

25. The method according to claim 24, wherein the generating an input vector comprises:
duplicating each of the plurality of components of the input data according to the number of duplicated non-leaf nodes in the given layer, giving rise to a plurality of duplicated component vectors;
providing an input mask for each given duplicated component vector according to position of one or more duplicated non-leaf nodes in the given layer, the one or more duplicated non-leaf nodes associated with a duplicated condition to be applied on the component comprised in the given duplicated component vector, giving rise to a plurality of input masks corresponding to the plurality of duplicated component vectors;
applying the plurality of input masks to the corresponding plurality of duplicated component vectors, giving rise to a plurality of masked duplicated component vectors; and
combining the plurality of masked duplicated component vectors to form the input vector.

26. The method according to claim 17, wherein the combining the plurality of corrected per layer outputs comprises applying an AND operation among the plurality of corrected per layer outputs.

27. The method according to claim 17, wherein the processor supports SIMD and wherein at least one of the providing appropriate components to corresponding duplicated non-leaf nodes, the applying the duplicated condition on the corresponding appropriate component, the applying an inversion mask to the per layer output and the combining the plurality of corrected per layer outputs is performed, by the processor, in parallel for at least part of duplicated non-leaf nodes in the given layer.

28. The method according to claim 17, wherein the processor supports SIMD and comprises a plurality of multi-component registers each having a fixed width and data corresponding to each layer of the restructured tree exceeds the fixed width, and wherein the restructured tree is divided into a plurality of sub-trees such that at least one sub-tree of the plurality of sub-trees utilizes the fixed width.

29. The method according to claim 17, wherein the processor supports SIMD and comprises a plurality of multi-component registers each having a fixed width capable of holding data corresponding to at least one layer of at least one restructured tree, and wherein the data is packed into the plurality of multi-component registers and is processed by the processor in parallel.

30. The method according to claim 28, wherein data corresponding to at least one layer from at least one sub-tree is packed into the plurality of multi-component registers and processed by the processor concurrently.
